(19) United States
(12) Patent Application Publication
(10) Pub. No.: US 2006/0008575 A1
(43) Pub. Date: Jan. 12, 2006

(54) Flowable topping compositions and methods of making and using same

(76) Inventors: Alyssa L. Armbrecht, Plymouth, MN (US); Elizabeth Melcher, Shoreview, MN (US)

Correspondence Address: Annette M. Frawley, Esq.;Patent Counsel, Number One General Mills Boulevard, Minneapolis, MN, 55426, US

(21) Appl. No.: 10/889,376

(22) Filed: Jul. 12, 2004

(51) Int. Cl. A23G 3/00

(52) U.S. Cl. 426/659

(57) ABSTRACT

The invention provides an edible composition having a controlled viscosity profile, the composition composed of sweetening agent, shortening, emulsifier, and viscosity enhancer comprising cellulose, starch, and polysaccharide gum. Preferably, the inventive topping composition has a moisture content in the range of 10 to 20%. The controlled viscosity profile includes an initial viscosity at ambient temperatures, an intermediate, flowable viscosity at elevated temperatures, and a final, set, texture when cooled that resembles the initial viscosity.

### FIELD OF THE INVENTION

The invention relates to food products. More particularly, the invention relates to edible compositions for use as toppings, such as frostings or spreads, for food products.

### BACKGROUND OF THE INVENTION

There are several types of confectionary products that are used as toppings to sweeten and/or decorate baked goods such as cakes, breads, cookies, and the like. These products can be categorized into several basic types depending, in part, upon whether the products contain shortening, how much shortening the products contain, and/or whether the products are aerated. Some examples of such products include icings, frostings, and dipping compositions.

Icings typically refer to compositions containing primarily sugar and water, and optionally, adjuvants such as emulsifiers to enhance storage stability. As an important characteristic, these compositions generally harden to form firm, nonsticky toppings. Within the broad category of icings, flat icings are not substantially aerated, are set, and do not flow at room temperature. Flat icings are distinguishable from aerated icings that flow at room temperature, with the application of a minimal pressure. A typical flat icing has a sucrose concentration range of about 70% to 73% by weight. Generally, icings are thinner, more liquid compositions than frostings. Moreover, as an icing dries it thins out, becomes smooth across the surface of the food product, and hardens. Icing is typically piped onto a food product surface, since it will run off the edges of the food product if spread with a utensil such as a knife.

In contrast, frostings are thick compositions that hold shapes once applied to a food product. Once applied to a food product, frostings typically remain soft to the touch and have a creamy texture. Frostings can be applied by using a utensil, such as a knife or rubber spatula to spread the frosting across the surface of the food product. Alternatively, frostings can be placed in a pastry or decorating bag fitted with a small tip and piped out in thin lines or decorations onto the food product.

Frosting compositions are commercially available in a variety of forms. One such variety includes ready-to-spread (“RTS”) frosting compositions. Generally, RTS products are products that can be directly applied from the container to a desired food by the consumer without the requirement of additional preparation steps prior to the application. Typically, RTS frostings are stored unopened at room temperature for extended times (for example, 9 months to one year or more) or stored after opening at refrigerator temperatures for shorter times (for example, 2 weeks to 30 days). RTS frostings are applied directly from the container to a cake or other baked good after stirring. RTS frostings are thus formulated so as to be usable without requiring further preparative steps or additional ingredients. RTS frostings form a discrete category of frostings because of their extended shelf lives.

Desired organoleptic and performance properties for RTS frostings include a smooth texture, a “short” consistency, spreadability without flowing or running, resistance to syneresis or weeping in the unopened container, resistance to syneresis or weeping between cake layers or on top of cupcakes upon overnight storage of a frosted product, and a light density (for example, 0.75 to 1.15 g/cc). Generally, RTS frostings typically comprise about 11-20% water, about 5-15% fat, about 40-60% sugar, and about 0.3-1.5 of an emulsifier (although some commercially available RTS frostings include as much as 25% fat).

While popular, RTS frostings can have some limitations. For example, a consumer is typically directed to allow a cake (or other baked good) to cool completely, often for one hour or more, before applying the frosting. Therefore, baking a cake, waiting for it to cool, and frosting the cake could require hours of preparation time. Further, the action of spreading the frosting over the cake can result in tearing the surface of the cake, which results in an undesirable appearance of the product.

On a separate subject, a dipping chocolate has recently become commercially available. This dipping chocolate consists of semi-sweet chocolate (sugar, chocolate, cocoa butter, soy lecithin as an emulsifier, vanilla extract, salt, and milk solids) provided in the form of discrete solid pieces. Directions for the composition instruct the consumer to place the solid composition in a microwave and microwave on high setting for 30 seconds, stir, and repeat these steps until the chocolate is fully melted and smooth. Instructions include suggestions to make sure fruit and utensils are dry before dipping, since moisture will cause the chocolate to clump together. If desired, the heated product can be cooled to a hard shell (for example, once a fruit or other food product has been dipped into the composition). The product is intended as a dipping composition for such foods as fresh fruits, dried fruit, nuts, marshmallows, cookies, pound cake pieces, and pretzels. This food product is thus provided in an initial, dry, solid state that is heated to provide a dippable state. After heating, the dipping composition cools to form a hardened coating on the food product.

Thus, currently available topping compositions (including icings, frostings, and dipping compositions) do not provide the ability to control the texture of the composition by heating and cooling. Rather, if the compositions are heated for application to a food product, they typically cool and harden to a consistency that is substantially different from the initial consistency of the composition. Heating of the compositions, if attempted at all, changes the rheological properties of the compositions in a permanent manner.

### SUMMARY OF THE INVENTION

The invention relates generally to an edible food product, preferably a topping composition that has a controlled texture. The topping composition can be stored for extended periods at ambient temperatures, where the topping composition exhibits an initial texture, having a viscosity in the range of about 400,000 centipoise to about 700,000 centipoise (cps, also referred to as cP). Once heated to a temperature in the range of approximately 90° to 105° F. (for example, by application of microwave heating, by heating in a saucepan on the stovetop on low heat while stirring, or by heating in a bowl of hot tap water), the topping composition exhibits an intermediate, flowable texture, having a viscosity in the range of about 70,000 cps to about 160,000 cps. After application onto a food product, such as a baked good, the topping composition is allowed to cool to ambient temperatures, and the composition resumes a final texture, with a viscosity approximating the initial viscosity of the composition. Preferably, this final viscosity is in the range of about 230,000 cps to about 330,000 cps. This final viscosity allows the topping composition to “set” on a cake, such that the topping composition remains on the cake and does not flow off the sides of the cake. As a result of this controlled texture profile, the topping compositions provide a convenient product that can be poured over a baked good as a topping (such as a frosting).

Further, the topping compositions, after application to a baked good and subsequent cooling, exhibits a moist, creamy texture that resembles its initial texture. In preferred embodiments of the invention, heating of the topping compositions temporarily changes the rheological properties of the compositions, to allow application of the compositions to a baked good. After application, the topping compositions are permitted to resume a texture similar to the original texture of the composition (at ambient temperatures, before application of heat), thus providing a rich, creamy, topping composition for food products such as baked goods.

Surprisingly, it has been discovered that manipulation of the topping composition allows the user to apply the topping to a wide variety of food products having a variety of temperatures. In one preferred embodiment, for example, the topping can comprise a frosting that is capable of being applied to a warm cake (for example, a cake having an average temperature above 140° F. or even above 175° F.). In preferred embodiments, the frosting does not compromise the integrity of the warm cake, such as by running off the cake.

In one aspect, the invention relates to topping compositions that include a novel viscosity enhancer that is composed of a combination of a cellulose, starch, and polysaccharide gum. In another aspect, the invention relates to methods of preparing topping compositions that exhibit controlled viscosity profiles, the methods involving premixing the elements of the viscosity enhancer prior to adding the viscosity enhancer to the other components of the topping composition.

More particularly, the invention provides flowable topping compositions having a controlled viscosity profile, the compositions comprising on a weight basis:

a. 40 to 70% sweetening agent;

b. 15 to 25% shortening;

c. 0.5 to 2% emulsifier;

d. 10 to 20% moisture; and

e. viscosity enhancer comprising cellulose, starch, and polysaccharide gum.

In other aspects, the invention provides flowable topping compositions comprising sweetening agent; shortening; emulsifier; and viscosity enhancer in an amount in the range of 0.5 to 3% on a weight basis, the viscosity enhancer comprising cellulose, starch, and polysaccharide gum, wherein the flowable topping composition has a moisture content of 10 to 20%.

In still other aspects, the invention provides flowable topping compositions comprising sweetening agent, shortening, emulsifier, and viscosity enhancer comprising cellulose, starch, and polysaccharide gum, wherein the topping composition exhibits an initial viscosity in the range of 400,000 cps to 700,000 cps at ambient temperatures, an intermediate viscosity, when heated to a temperature in the range of 90° to 105° F. in the range of 70,000 cps to 160,000 cps, and a final viscosity, when cooled, in the range of 230,000 cps to 330,000 cps.

Methods of making the inventive topping compositions, as well as methods of using the topping compositions to make food products, are also contemplated in the invention.

The various aspects of the invention will now be described in more detail.

### BRIEF DESCRIPTION OF THE DRAWINGS

The accompanying drawings, which are incorporated in and constitute a part of this specification, illustrate several aspects of the invention and together with the description of the preferred embodiments, serve to explain the principles of the invention. A brief description of the drawings is as follows:

FIG. 1 is a graph illustrating the relationship of viscosity (centipoise, Y-axis) and temperature (° F., X-axis) of a control sample made in accordance with one embodiment of the invention.

FIG. 2 is a graph illustrating the relationship of viscosity (centipoise, Y-axis) and temperature (° F., X-axis) of a topping composition that did not include pectin.

FIG. 3 is a graph illustrating the relationship of viscosity (centipoise, Y-axis) and temperature (° F., X-axis) of a topping composition that did not include starch.

FIG. 4 is a graph illustrating the relationship of viscosity (centipoise, Y-axis) and temperature (° F., X-axis) of a topping composition that included half the amount of pectin of one embodiment of the invention.

FIG. 5 is a graph illustrating the relationship of viscosity (centipoise, Y-axis) and temperature (° F., X-axis) of a topping composition that included half the amount of starch of one embodiment of the invention.

FIG. 6 is a graph illustrating the relationship of viscosity (centipoise, Y-axis) and temperature (° F., X-axis) of a topping composition that did not include a starch.

FIG. 7 is a graph illustrating the relationship of viscosity (centipoise, Y-axis) and temperature (° F., X-axis) of a topping composition wherein the starch is undermixed in the composition.

FIG. 8 is a graph illustrating the relationship of viscosity (centipoise, Y-axis) and temperature (° F., X-axis) of a topping composition according to one embodiment of the invention, compared with commercially available topping compositions outside the scope of the invention.

FIG. 9 is a graph illustrating the relationship of viscosity (centipoise, Y-axis) and temperature (° F., X-axis) of a topping composition according to one embodiment of the invention, compared with commercially available topping compositions outside the scope of the invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

The present invention is directed to edible topping compositions having a controlled viscosity profile. In one preferred embodiment, the invention relates to topping compositions that can be used with baked goods such as cakes, cookies, donuts, cupcakes, muffins, croissants, waffles, biscuits, breads, rolls, and the like. To facilitate the discussion of the invention, use of the invention as a frosting for baked goods, such as cakes, will be addressed. Frosting compositions for baked goods are selected because the advantages of the invention can be clearly presented. However, it is understood that the compositions and methods disclosed are applicable to any flowable topping needs, for example, preparation of flowable toppings that can be used with a wide variety of food products, such as baked goods, ice cream, and the like.

In its product aspect, the invention provides topping compositions that exhibit controlled viscosity profiles. At ambient temperatures, the topping compositions provide shelf stable, intermediate moisture compositions that have an initial viscosity resembling that of typical RTS frostings. When heated, the topping compositions exhibit an intermediate, flowable viscosity, which allows the topping composition to be applied to a variety of food substrates that exhibit a variety of temperatures. For example, in one preferred embodiment described herein, the topping composition can be applied to a warm cake. After the topping composition has been applied to the food substrate, the topping composition is permitted to cool (for example, at ambient temperatures), during which time the topping composition assumes a final viscosity that resembles the typical viscosity of a frosting composition. This final viscosity provides a “set” topping on the food product, such as a “set” frosting on a cake.

It has been surprisingly discovered that a viscosity enhancer, which comprises a selected combination of agents, can be incorporated into topping compositions to provide controlled texture, or viscosity, to the topping composition. Moreover, the inventive topping composition preferably has a creamy, smooth texture, “short” consistency, light density, flowability without running off the cake, resistance to sinking into the cake, and resistance to weeping or syneresis. “Shelf stable” refers to the compositions of the invention being suitable for storage at ambient temperatures (such as room temperature) without the food composition substantially breaking down by, for example, microbial contamination, syneresis or weeping, water accumulation, and the like, and becoming unsuitable for consumption.

Throughout the specification and claims all percentages used herein are in weight percentages, and are based upon the total weight of the topping composition, unless otherwise specifically noted. Temperatures are represented in degrees Fahrenheit unless otherwise indicated.

According to the invention, topping compositions having a controlled viscosity profile include, as major ingredients, sweetening agent, shortening, and water with minor ingredients including emulsifier and viscosity enhancer comprising cellulose, starch, and polysaccharide gum. Further, the inventive topping compositions preferably have a moisture content within a desired range. Each of these aspects will be described in more detail.

Sweetening Agent

A nutritive carbohydrate sweetening agent or “sugar(s)” is the principal essential ingredient in the inventive topping composition. The sugar can provide bulk and body to the topping and can contribute to the organoleptic properties of the frosting, such as sweetness, texture, consistency, viscosity, density, and taste.

Useful as the sweetening agent herein is any of a variety of edible oligosaccharides having one, two, or more saccharide groups, including, for example, sucrose, fructose, dextrose, maltose, lactose, galactose, sorbitol, and mixtures thereof. These sugars can be used in any of a variety of conventional forms, such as, for examples, cane sugar, beet sugar, corn syrup, corn syrup solids, brown sugar, maples sugar, maple syrup, honey, molasses, and invert sugar. Preferably, the sweetening agent of the topping composition is selected from sucrose, fructose, dextrose, maltose, and mixtures thereof. In some preferred embodiments, the sweetening agent is a mixture of sucrose and corn syrup, which generally is a mixture of dextrins, maltose, fructose, and dextrose. In some preferred embodiments, the sweetening agent is comminuted sucrose.

Various particle sizes are commonly available for sucrose, known in the trade as 6x, 10x, and 12x. The 12x ground sucrose, that is, powdered sugar having an average particle size of 30 μm or less, is preferred in the topping compositions of the invention. Typically, finely divided sugars can be combined with a small amount, for example 3 to 6%, of a processing agent (a free flow agent), such as wheat starch, for advantageous conveyance in a commercial process.

The total amount of sweetening agents in the topping composition is adjusted within the present concentration ranges such that the appropriate sweetness level and suitable organoleptic properties are obtained for a storage stable flowable topping composition. Suitable organoleptic properties of the topping composition include smooth texture, short consistency, flowability, and a density in the range of about 1 to about 1.2, typically in the range of about 1.05 to about 1.15, or about 1.09 to about 1.13 g/cc. Typically, the total level of sweetening agents in the present topping composition is in the range of about 40% to about 70%, or about 55% to about 65%.

In some embodiments, the sweetening agent can comprise a blend of sucrose and corn syrup that also functions as a plasticizer and humectant. Also, the syrup can function to stabilize the composition and to inhibit the growth of sucrose crystals that can impart undesirable “grittiness” to the product. In these embodiments, sucrose (including up to about 4% wheat starch based upon the weight of the topping composition) can comprise about 40% to about 70%, or about 40% to about 55% of the topping composition. The corn syrup is present in an amount such that the flowability of the topping is enhanced, and maintained for a desired period of time, relative to commercially available RTS frostings. Corn syrup can be present in an amount of about 1 to about 25%, or about 5 to about 15% of the topping compositions.

The sweetness of cereal syrups such as corn syrups is expressed in dextrose equivalents (DE), with a higher number representative of a sweeter material. Useful in the inventive topping compositions are high maltose corn syrups, such as those available from Cargill, Inc.

Corn syrups can be isomerized to form high DE corn syrups, for example with a DE level in the range of about 60 to about 90 DE, which can be used to make high-fructose corn syrups, which are blends of fructose and glucose. Pure fructose or high-fructose corn syrups containing about 42% to about 55% fructose can be used as the sweetening agent in the topping formulations of the invention, preferably in combination with sucrose. Typically, high corn syrup levels will increase the flowability of the topping compositions. Thus, the amount of corn syrup in the inventive compositions will be controlled to avoid a composition that exhibits undesired flowability and/or syneresis. Fructose can be present in the topping compositions in an amount in the range of about 0.1 to about 20%, or about 2 to about 10%.

Fructose tends to lower the water activity (Aw) of the topping compositions. Water activity is a known measure of the amount of chemically available water (water that is not chemically bound). The lower the water activity of a topping composition, the less likely it is to dry out and harden. Furthermore, with a lower water activity, solid particulates can be used, such as chips, without degrading the particulates. Also, compositions having lower water activity will generally support less microbial growth, which results in the reduction or elimination of preservatives from the composition. As the amount of fructose increases, the water activity of the topping composition decreases. The water activity of the topping compositions of the invention are typically about 0.8, or in the range of about 0.78 to about 0.81.

Shortening

Another component in the flowable composition of the invention is shortening. Shortening comprises fats, oils, and other lipid-containing materials. Fats and oils commonly used in food include glycerol esters of fatty acids, known as triglycerides or triacylglycerols, and products derived therefrom.

The shortening in the present invention can be obtained from a variety of sources including animal and vegetable sources. Preferably used are shortenings derived from vegetable oils such as corn, soybean, peanut, cottonseed, sesame, sunflower, rapeseed, olive, coconut, palm, and other oils.

Generally, the shortening used according to the invention provides body and mouthfeel to the composition, as well as carrying flavors, retaining moisture and tenderizing the composition. In addition, the shortening can affect product density by aiding in the incorporation and/or retention of air.

A preferred shortening blend used in this invention comprises partially hydrogenated soybean oil and partially hydrogenated cottonseed oil, for example, a blend composed of 92% soybean oil and 8% cottonseed oil. In an alternative embodiment, the shortening blend can contain hydrogenated and deodorized coconut oil in an amount in the range of about 1% to about 5% of the total formula, which is about 10% of the shortening level.

Shortenings are usually classified according to their solid-fat-index (SFI). The SFI relates to the proportion of material that remains solid in the shortening at a specified temperature. Preferred SFI profiles of the shortening blend comprising partially hydrogenated soybean oil and partially hydrogenated cottonseed oil according to the invention are as follows:

| | SFI - partially hydrogenated | |
|---|---|---|
| | soybean oil and partially | |
| Temperature | hydrogenated cottonseed oil | SFI - coconut oil |
| 50° F. (10° C.) | 27.5-33.5% | 60.5-67.5% |
| 70° F. (21° C.) | | 36.5-43.5% |
| 80° F. (27° C.) | 14.5-20.5% | 8.5-15.5% |
| 92° F. (33° C.) | | 4.5% or less |
| 104° F. (40° C.) | 5.5-9.5% | 1.5% or less |

According to the invention, the shortening component comprises 15-25 weight percent of the composition.

Emulsifier Component

The inventive topping compositions further comprise an emulsifier component. The emulsifier component can aid in reducing interfacial tension in oil/water emulsions, facilitate emulsification, and increase emulsion stability. The emulsifier component can also aid in providing a shorter texture, more flowable consistency, body, and a creamy mouthfeel. Emulsifiers can further stabilize the water and fat components of the composition, provide the desired texture and mouthfeel attributes in the inventive compositions, increase the viscosity, and prevent composition breakdown due to moisture weeping or oil separation. Emulsifiers can also effectively aid in aerating the final product toward its target density of 1.0 to 1.2 g/cc.

All or part of the emulsifiers can be added directly to the topping composition as convenient. Further, some emulsifiers can be prehydrated by addition to the water before being incorporated into the topping composition.

The major constituent of the emulsifier component is preferably a monoglyceride. Distilled monoglycerides are preferred from a cost standpoint compared to a blend of mono- and diglycerides since distilled monoglycerides are less expensive based upon the active ingredient. The monoglycerides affect the fat properties of the shortening. More particularly, these emulsifiers increase and/or aid the dispersion of the fat throughout the sugar syrup of the topping composition. The monoglyceride emulsifier preferably is a mixture of monoglycerides of higher fatty acids. A preferred emulsifier is a mixture of purified, partially saturated monoglycerides, composed of glyceryl monostearate and glyceryl monopalmitate, and small quantities of other fatty acid monoesters. In preferred embodiments, it is prepared from partially hydrogenated refined palm oil and other partially hydrogenated vegetable oils, then concentrated by molecular distillation.

Typically, the distilled monoglyceride will contain low levels of other materials, such as diglcyerides and/or monoglycerides of other fatty acids or degrees of unsaturation. Mono- and diglyceride blends can be used if their monoglyceride fraction has the desired iodine value and fatty acid chain length. Preferably, the inventive topping compositions comprise monoglyceride in an amount in the range of 0.2 wt-% to 1 wt-%, or 0.3 wt-% to 0.75 wt-%.

Preferably, the emulsifier component is prepared as a slurry mix that is added to the topping composition. In one such embodiment, water is heated to 1 55° F. (±5° F.) in a high-shear Breddo mixer. While the Breddo is running on low speed, emulsifiers are added and blended to hydrate. In preferred embodiments, the emulsifier slurry is about 140° F. when used, with a pH in the range of 4.8 to 7.5.

The total amount of emulsifier in the topping compositions of the invention is adjusted such that suitable organoleptic properties are obtained. That is, the total level of emulsifiers is adjusted such that the topping compositions have a creamy, rich mouthfeel, a smooth texture, a short consistency, flowability, and a density in the range of 1 to 1.2 g/cc at a temperature in the range of 93° F. to 103° F.

Optionally, the emulsifier component can further include additional emulsifiers. Suitable additional emulsifiers include unmodified monoglycerides, mono- and diglyceride blends, triglycerol monostearate, sorbitan esters, propylene glycol fatty acid esters, and/or lecithin. Exemplary useful high HLB emulsifiers include ethoxylated monoglycerides, polysorbates, ethoxylated sorbitans, decaglycerol esters (such as decaglycerol dipalmitate).

The inventive topping compositions preferably comprise an emulsifier component in an amount in the range of 0.5 to 2%, or 0.6 to 1.8%, or 0.8 to 1.7%. One exemplary emulsifier component includes 0.3 to 0.8% monoglycerides, 0.2 to 0.3% polysorbate, 0.1 to 0.3% Datem/SSL, and 0.04 to 0.06% sodium hydroxide. One of skill in the art can readily adjust the amount of sodium hydroxide to achieve the desired pH in the compositions.

Viscosity Enhancer

According to the invention, the inventive topping compositions include a viscosity enhancer. Preferably, the viscosity enhancer comprises a combination of selected viscosity agents, namely, cellulose, starch, and polysaccharide gum. The viscosity enhancer can provide the finished topping composition with a desirable body and texture.

Surprisingly, when a combination of cellulose, starch, and polysaccharide gum are included in a topping composition as herein described, the resulting topping composition exhibits a controlled viscosity profile. In preferred embodiments, the viscosity enhancer comprises three components: a cellulose, starch, and polysaccharide gum. While the description herein describes the viscosity enhancer as including one component from each of these groups, it is understood that more than one cellulose compound, starch, and/or polysaccharide gum can be included in the viscosity enhancer, as desired.

Suitable cellulose compounds are water-soluble food polysaccharides that are derived from cellulose. Suitable cellulose compounds include, for example, hydroxypropyl cellulose (HPMC), microcrystalline cellulose (MCC), methylcellulose (MC), carboxymethylcellulose (CMC), and sodium carboxymethylcellulose. A preferred cellulose gel is a water-soluble, microcrystalline cellulose. One example of such a microcrystalline cellulose is commercially available as Avicel™, available from Food and Pharmaceutical Products Division of FMC Corporation, Philadelphia, Pa.

Suitable starches can be selected from a variety of commercially available products. Commercial starches are obtained from cereal grain seeds, particularly from corn, waxy corn (waxy maize), high-amylose corn, wheat, various rices, barley, and from tubers and roots, particularly potato, sweet potato, tapioca (cassava), sorghum, arrowroot, or mixtures thereof. Native starches and/or modified starches can be utilized in accordance with the invention.

Starch is a mixture of linear (amylose) and branched (amylopectin) polymers of alpha-D-glucopyranosyl units, which can be subjected to chemical or physical modification to alter some of the native characteristics, such as viscosity, gel strength, and the like. Starch granules contain an elutable amylose fraction and a branched amylopectin fraction. When starch granules are contacted with water and heated above a temperature designated as the gel point, the granules begin to bind water and swell. The gel temperature for a particular starch variety depends upon a number of factors, including particle size, pH, and absolute concentration. Particularly advantageous starches are those classified as cold-water-swelling starches, which includes pregelatinized starches.

Starches serve a variety of roles in food production, and they are principally used to take up water and to produce viscous fluids/pastes and gels and to give desired textural qualities. Under normal food processing conditions, starch granules can quickly swell beyond the reversible point. Water molecules can enter between the chains, break interchain bonds, and establish hydration layers around the separated molecules. Because the highly swollen granules can break easily, the viscosity can quickly decrease with only moderate shear. As a result, starches are often modified before use in foods.

Modification of starches is done so that resultant pastes can withstand the conditions of heat, shear, and acid associated with particular processing conditions and to introduce specific finctionalities. Modified starches include starches that are chemically or physically modified. Types of modifications that are most often made, sometimes singly, but often in combinations, are crosslinking of polymer chains, non-crosslinking derivatization, depolymerization, and pregelatinization. Physically modified starches for food uses include pregelatinized starch, granual-cold-water soluble starch and resistant starch. Pregelatinized starch can be prepared by drum-drying pre-cooked starch paste; granual-cold-water soluble starches can be prepared by heating or by alkaline-treatments in an aqueous alcohol medium.

Chemical modification can be achieved via reactions such as esterification with acetic anhydride, succinic anhydride, the mixed anhydride of acetic and adipic acids, 1-octenylsuccinic anhydride, phosphoryl chloride, sodium trimetaphosphate, sodium tripolyphosphate, and monosodium orthophosphate; etherification with propylene oxide; acid modification with hydrochloric and sulfuric acids; bleaching with hydrogen peroxide, peracetic acid, potassium permanganate, and sodium hypochlorite, oxidation with sodium hypochlorite; and various combinations of these reactions. Modified and native starches are well known and will not be described further herein, and one of skill in the art, upon review of this disclosure, can select the appropriate modified and/or native starches for use in accordance with the inventive concepts.

One preferred starch according to the invention is commercially available under the product name AdvantaGEL™, from National Starch, Bridgewater, N.J.

Pregelatinized starches can be useful, at least in part, because of their reduced contributions to flavor and mouthfeel in the final food product. A wide variety of commercially available pregelatinized starches can be used in the formulations of the invention. The choice of the particular pregelatinized starch depends upon the desired texture and mouthfeel of the final product.

Further, cold-water swelling starches can be utilized, such as waxy maize, corn/regular maize, and tapioca starches. These and other cold-water swelling starches are commercially available, such as from National Starch.

Suitable polysaccharide gums include agar; agar-agar (a polysaccharide extracted from certain marine red algae); algins (alginate, a polysaccharide extracted from giant brown seaweed); pectin, carageenan (a complex mixture of sulfated polysaccharides extracted from red seaweed, such as kappa and iota carageenan); xanthan gum; guar gum; locust bean gum; gellan gum; gum arabic.

In addition to the three major components of the viscosity enhancer, additional gelling agents can optionally be included in the inventive compositions. For example, gel forming proteins, such as gelatin can be included in some embodiments. Suitable gel-forming proteins typically have a bloom strength of at least about 200, which is representative of a moderate to high strength gel-forming material.

The amount of viscosity agents (the amount of each individual component) of the overall viscosity enhancer can vary depending upon the desired end product attributes. In preferred embodiments, the major component of the viscosity enhancer is the starch component. For example, in some embodiments, the starch component comprises at least 40%, or at least 49% of the viscosity enhancer. In some illustrative embodiments, the starch component comprises 40 to 90% of the viscosity enhancer. The balance of the viscosity enhancer is composed of the cellulose and polysaccharide gum. In some embodiments, the amount of cellulose and polysaccharide gum present in the viscosity enhancer is equal. Alternatively, either the cellulose or polysaccharide gum can be present in a greater amount than the other component. The determination of the precise amount of the individual components of the viscosity enhancer can be readily determined, utilizing the teaching herein, and routine experimentation, for desired attributes of the topping composition.

The viscosity enhancer is present in the topping composition in an amount effective to achieve the desired viscosity profile. In some embodiments, the viscosity enhancer is present in the topping composition in an amount in the range of 0.5% to 3%, or 1% to 2%.

In preferred embodiments, the topping composition including a viscosity enhancer exhibits thixotropic flow properties. Generally, thixotropic flow is a type of shear-thinning flow, wherein an increase in flow results from an increase in shear rate. In contrast to pseudoplastic flow, the viscosity reduction that results from an increase in the rate of flow does not occur instantaneously. The viscosity of thixotropic solutions decreases under a constant rate of shear in a time-dependent manner and regains the original viscosity after cessation of shear, but only after a time interval. This behavior is due to a gel→solution→gel transition.

The combination of cellulose, starch, and polysaccharide gum in the viscosity enhancer to provide a flowable topping composition having a controlled texture is surprising. The selection and combination of these three components provides a synergistic effect, where deletion of even one of the components impacts the controlled viscosity profile of the inventive compositions. As shown in the examples, when a single component of the viscosity enhancer is deleted, the resulting topping composition does not provide a final, “set” viscosity.

Moisture Content

The inventive topping compositions include a moisture content in the range of 10% to 20%, or in the range of 11% to 17%. This moisture content is similar to standard ready-to-spread (RTS) frostings. The water can be added separately or can be provided as part of other frosting components (such as corn syrup). Conventional potable water, preferably distilled water, which is substantially free of objectionable taste, colors, odors, and of approved bacteriological quality, is preferably used.

It is known that the moisture content can have an influence on a frosting's viscosity. Too much water can produce a frosting that is too runny or has a wet consistency. Too little water can produce a frosting that is too thick and/or difficult to apply to a baked good (such as by frosting a cake). Conventional RTS frostings typically have viscosities in the range of 15-90 (direct viscometer readings on product transferred to a 233 cc cup, which is equal to 75,000-450,000 cps) at ambient temperature (70° F., 21° C.), as measured by a Brookfield Model RV viscometer with a heliopath stand at 20 revolutions per minute using a T-bar -F spindle. The inventive topping compositions exhibit viscosities that overlap with an upper portion of this range at ambient temperature. However, once heated the inventive compositions exhibit an intermediate viscosity in the range of about 70,000 cps to about 160,000 cps at a product temperature in the range of approximately 90° to 105° F., measured using the procedure above. After heating, the inventive compositions can then be cooled to ambient temperature, where the compositions resume a viscosity similar to the initial viscosity of the product. For example, the final viscosity can be in the range of about 230,000 cps to about 330,000 cps. Illustrative formulations providing this controlled viscosity profile are illustrated in the Examples.

The novel viscosity enhancers described herein provide improved topping compositions having an unique viscosity profile compared to conventional frosting compositions. The inventive compositions provide many of the desirable characteristics of conventional frostings, such as creamy mouthfeel and short texture, while providing a desirable viscosity profile for ease of use.

Optional Additives

Optionally, the inventive compositions can further include a variety of adjuvant materials to modify the nutritional, organoleptic, flavor, color, or other properties of the composition. For example, the topping compositions can additionally include fat replacers such as sucrose polyesters or hydrated colloidal protein dispersions (such as SIMPLESSE fat replacer, available from the NutraSweet Company). The inventive compositions can optionally include sugar replacers or bulking agents, such as polydextrose, low DE maltodextrins, or other known compounds.

Additionally, synthetic and natural flavorings or coloring agents can be used in the topping compositions of the invention. Exemplary flavors include cream or cream cheese flavor, milk powder, chocolate, vanilla extract, vanilla powder, cocoa substitute, hazelnut, dutched cocoa, mint, lemon, and mixtures thereof. Also, flavor materials and particulates, such as fruit and fruit extracts, nuts, chips, and the like, can be added to the frosting compositions as desired. The flavoring agents can be used in amounts in the range of about 0.01 to about 8.5%. Coloring agents can be used in amounts in the range of about 0.01 to 0.05%.

Other additives can be present in the inventive topping compositions in minor amounts, for example, less than about 1%, or less than about 0.5%, if desired. Such additives can include, for example, salt, whiteners (such as titanium dioxide and the like), mold inhibitors (such as potassium sorbate, sorbic acid, sodium benzoate, and the like), sequestering agents (such as fat sequestering agents, for example, sodium acid pyrophosphate), acidulants, buffers, food acids, preservatives, antioxidants (such as butylated hydroxytoluene, butylated hydroxyanisole, tertiary-butyl hydroquinone (TBHQ), and the like), vitamins, minerals, and the like.

Processing

As discussed herein, the inventive topping compositions involve a novel viscosity enhancer that is composed of a combination of cellulose, starch, and polysaccharide gum. In preferred embodiments, the novel viscosity enhancer is incorporated into the topping composition in such a manner to provide desired characteristics such as, for example, viscosity, texture, and emulsion stability. In some aspects, the viscosity enhancer is incorporated into the topping composition in a manner to allow the components to be fully hydrated and/or fully dispersed in another medium and therefore fully functional in the final composition.

In one embodiment, the cellulose compounds selected are prepared in one hydrocolloid slurry, while the polysaccharide gums are prepared in a separate hydrocolloid slurry. The two slurries are then combined. The starch is dispersed in sucrose and added to the combined hydrocolloid slurries. In one such embodiment, the cellulose gum/gel slurry can be prepared by adding them to water (for example, at a temperature in the range of 60° to 80° F.), and mixing for a time at a speed effective to hydrate the cellulose. The polysaccharide gums can be prepared in a slurry by adding them to water (for example, at a temperature in the range of 110° to 150° F.) and mixing for a time and at a speed effective to hydrate the polysaccharide gums. The hydrocolloid slurries can then be combined, and the starch selected is added to the combination after it is dispersed in sucrose.

Specific examples of some embodiments of the methods according to the invention can be found in the Examples.

Once formulated, the flowable topping product can then be packaged in a conventional manner for handling and storage purposes. Optionally, the packaging can include instructions for preparation of a topped food product using the flowable topping product.

To prepare topped food products for consumption, the user places the flowable topping product in a microwave and heats the product on high setting for 20 seconds. The flowable topping is then stirred thoroughly (for example, twenty times) until smooth. At this point, the topping should be flowable, such that the topping product can be poured onto a food product, yet thick enough to spread. If the topping is too thick (viscous) to pour, the user can heat the topping for an additional amount of time (for example, 5 to 10 seconds or longer), until the desired viscosity is achieved.

Once the desired viscosity is achieved, the topping is poured over a food product and spread evenly. In one embodiment, when the flowable topping is used to frost a cake, the topping can be poured over a warm cake (for example, a cake that has been cooled at least 15 minutes).

The inventive topping compositions are particularly suitable for use as a packaged good for both the grocery retail trade to consumers and the institutional and food service markets.

### EXAMPLES

For the following examples, viscosity measurements were taken as direct viscometer readings on product transferred to a 233 cc cup at ambient temperature (70° F., 21° C.), as measured by a Brookfield Model RV viscometer with a heliopath stand at 20 revolutions per minute using a T-bar -F spindle. For conversion to centipoise (cp), the direct viscosity reading was multiplied by 5000.

### Example 1

A flowable, vanilla frosting was prepared having the following formulation:

TABLE 1
Flowable, vanilla frosting

| | Amount |
|---|---|
| Ingredient | (weight percent) |
| Sweetening agent, including sugar and corn syrup | 56.2 |
| Shortening | 25 |
| Water | 11.5 |
| Starch wheat | 4.0 |
| Starch potato | 0.5 |
| Distilled monoglycerides | 0.38 |
| Datem | 0.13 |
| Polysorbate 60 | 0.25 |
| Sodium hydroxide | 0.09 |
| Cellulose gel/cellulose gum | 0.31 |
| Pectin | 0.25 |
| Fat sequestering agent | 0.10 |
| Flavors/color/preservatives | 1.24 |

Emulsifier Slurry

An emulsifier slurry was prepared to include the following ingredients:

Sodium hydroxide

Monoglycerides

Datem

Polysorbate 60

To prepare the emulsifier slurry, hot water (150°-160° F.) was drawn into a high-shear Breddo mixer. While mixing on low speed, the emulsifiers were added in the following order: sodium hydroxide, monoglycerides, and Datem. The combination was blended for 1 minute. Next, polysorbate 60 was added while blending, and the mixture was blended until completion of the 10-minute cycle. The mixture was then blended on low speed for 10 seconds before drawing the emulsifier to the mixer. The emulsifier slurry was maintained at a minimum temperature of 140° F. for processing. Target pH was 4.8 to 5.8.

Hydrocolloid Slurry

A hydrocolloid slurry was prepared to include the following ingredients:

Cellulose gel/cellulose gum

Sugar

Corn Syrup

To prepare the hydrocolloid slurry, 60-80° F. water was drawn into a Breddo mixer. While mixing on high speed, flavor and a mixture of Avicel™ cellulose gel, carboxymethylcellulose, and sugar were added to the Breddo mixer. The mixture was blended 10 minutes on high speed. The Breddo mixer was then set to low speed, and corn syrup was added. The mixture was then blended on high speed 3 minutes. After completion of the final mix cycle, mixing ceased. The mixture was blended on high speed for 10 seconds before drawing the cellulose gel/gum slurry into the mixer.

Pectin Slurry

A pectin slurry was prepared to include the following ingredients:

Pectin

Sugar

Minors, including salt

To prepare the pectin slurry, hot water (110-150° F.) was drawn into a Breddo mixer. While mixing on high speed, pectin and sugar were added. The mixture was blended 5 minutes on high speed. Minors, then salt were added while mixing on high speed. The mixture was then mixed on high for 5 minutes. After completion of both mix cycles, mixing was stopped. The mixture was blended on high speed for 10 seconds before drawing the pectin/minors slurry into the mixer.

Oil Blend

An oil blend was prepared to include the following ingredients:

Soybean/cottonseed oil blend

Coconut oil

To prepare the oil blend, a blend of soybean/cotton seed oils (92/8 by weight) at a temperature of 135-145° F. was mixed with coconut oil at a temperature of 120-130° F. Temperature of the oil blend mixture was 125-135° F. The oil blend was mixed 10 minutes before dropping to mixer.

Processing

A Littleford paddle mixer containing 4 smizers was set on 55% speed. The cellulose gel/gum slurry and pectin slurry were discharged to the mixer. Two-thirds of the total sugar (including wheat starch) was added to the mixer while blending for 90 seconds. The remainder of the sugar was discharged, and the mixture was blended 90 seconds. While blending, the emulsifier slurry was discharged to the Littleford mixer, and the mixture was blended 90 seconds, then blended and smized for 30 seconds.

The oil blend was added while blending, and the mixture was then blended for an additional 180 seconds. The mixture was then blended and smized for 30 seconds or to target density in the range of 1.09-1.13 cc/g.

The mixture was homogenized, then cooled in a scraped surface heat exchanger (for example, a votator) to an exit temperature of 86-92° F. The cooled product was packaged in tubs and stored at room temperature (70°-80° F.).

The frosting exhibited the following viscosities:

| | Direct Reading | Centipoise |
|---|---|---|
| Line-unstirred | 27-35 | 135,000-175,000 |
| 24 hours unheated | 54-66 | 270,000-330,000 |
| 24 hours heated | 25-31 | 125,000-155,000 |

### Example 2

A flowable, chocolate flavored frosting and a flowable, milk chocolate frosting were prepared having the following formulations:

TABLE 2
Flowable, chocolate and milk chocolate frostings

| | | Milk |
|---|---|---|
| | Chocolate Frosting | Chocolate Frosting |
| Ingredient | (wt-%) | (wt-%) |
| Sweetening agent, including | 46.2 | 49.2 |
| sugar and corn syrup | | |
| Shortening | 25 | 25 |
| Water | 16 | 15 |
| Starch wheat | 4 | 4 |
| Starch potato | 1 | 0.5 |
| Distilled monoglycerides | 0.38 | 0.38 |
| Sodium stearoyl lactylate | 0.13 | 0.13 |
| Polysorbate 60 | 0.25 | 0.25 |
| Sodium hydroxide | 0.05 | 0.05 |
| Pectin | 0.16 | 0.08 |
| Cellulose gel/cellulose gum | 0.18 | 0.22 |
| Fat sequestering agent | 0.10 | 0.10 |
| Flavors/color/preservatives | 6.5 | 5 |

The chocolate flavored frosting was prepared as described in Example 1, except for the following differences:

The target pH of the emulsifier slurry was 6.5-7.5.

A Littleford paddle mixer containing 4 smizers was set on 40% speed. The cellulose gel/gum slurry and pectin slurry were discharged to the mixer. Two-thirds of the total sugar (including wheat starch) was added to the mixer while blending for 60 seconds. The smizers were then started, and after 10 seconds of smizing, cocoa was discharged into the mixer. The mixture was blended and smized for 90 seconds. The remaining sugar was discharged into the mixer, and the mixture was blended and smized for 90 seconds. While blending, the emulsifier slurry was discharged to the mixer, and the mixture was then blended 90 seconds, followed by 30 seconds of blending and smizing.

The oil mixture was added while blending, and the resulting mixture was blended for 180 seconds. The mixture was then blended and smized for 180 seconds or to desired density of 1.09-1.13 cc/g.

The mixture was homogenized, then cooled in a scraped surface heat exchanger (for example, a votator) to an exit temperature of 86-92° F. The cooled product was packaged in tubs and stored at room temperature (70°-80° F.).

The product exhibited the following viscosities:

| | Direct Reading | Centipoise |
|---|---|---|
| Line-unstirred | 26.5-34.5 | 132,000-172,000 |
| 24 hours unheated | 55.5-65.5 | 277,000-327,000 |

For the milk chocolate flavored frosting, the mixture was homogenized, then cooled in a scraped surface heat exchanger (for example, a votator) to an exit temperature of 86-92° F. The cooled product was packaged in tubs and stored at room temperature (70°-80° F.).

The product exhibited the following viscosities:

| | Direct Reading | Centipoise |
|---|---|---|
| Line-unstirred | 25.5-33.5 | 127,000-167,000 |
| 24 hours unheated | 51.5.5-61.5 | 257,000-307,000 |

### Example 3

The synergistic effect of combining cellulose, starch, and polysaccharide gum to formulate a viscosity enhancer for use in a topping composition was observed as follows. All formulations were vanilla frostings.

As a control, a frosting composition was prepared having the following formula:

TABLE 3
Control, Formula #722:

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Potato Starch | 0.5 |
| Cellulose gel/cellulose gum | 0.31 |
| Pectin | 0.25 |
| Fat sequestering agent | 0.10 |
| Distilled monoglycerides | 0.38 |
| DATEM | 0.13 |
| Polysorbate 60 | 0.25 |
| Sodium hydroxide | 0.09 |
| Flavors/color/preservative | 1.24 |

The following formulations were prepared to illustrate the synergistic effect of the viscosity enhancer:

TABLE 4
Formula #723: No pectin

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Starch Potato | 0.5 |
| Cellulose | 0.31 |
| Fat sequestering agent | 0.10 |
| Distilled monoglycerides | 0.38 |
| Polysorbate 60 | 0.25 |
| DATEM | 0.13 |
| Sodium hydroxide | 0.09 |
| Flavors/color/preservatives | 1.24 |

TABLE 5
Formula #724: No potato starch

| Ingredient | Amount (weight percent) |
|---|---|
| Sweetening agent, including sugar and corn | 56 |
| syrup | |
| Shortening | 25 |
| Water | 11.8 |
| Starch Wheat | 4.0 |
| Cellulose gel/cellulose gum | 0.31 |
| Pectin | 0.25 |
| Fat sequestering agent | 0.10 |
| Distilled monoglyercides | 0.38 |
| Polysorbate 60 | 0.25 |
| DATEM | 0.13 |
| Sodium hydroxide | 0.09 |
| Flavors/color/preservative | 1.24 |

TABLE 6
Formula #725: ½ pectin

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Starch Potato | 0.5 |
| Cellulose gel/cellulose gum | 0.31 |
| Pectin | 0.125 |
| Fat sequestering agent | 0.10 |
| Distilled monoglycerides | 0.38 |
| Polysorbate 60 | 0.25 |
| DATEM | 0.13 |
| Sodium hydroxide | 0.09 |
| Flavors/color/preservative | 1.23 |

TABLE 7
Formula #726: ½ potato starch

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Starch Potato | 0.25 |
| Cellulose gel/cellulose gum | 0.31 |
| Pectin | 0.25 |
| Fat sequestering agent | 0.10 |
| Distilled monoglycerides | 0.38 |
| Polysorbate 60 | 0.25 |
| DATEM | 0.13 |
| Sodium hydroxide | 0.09 |
| Flavors/color/preservative | 1.24 |

TABLE 8
Formula #727: No Cellulose gel

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Starch Potato | 0.5 |
| Cellulose gum (CMC) | 0.03 |
| Pectin | 0.25 |
| Fat sequestering agent | 0.10 |
| Distilled monoglycerides | 0.38 |
| Polysorbate 60 | 0.25 |
| DATEM | 0.13 |
| Sodium hydroxide | 0.09 |
| Flavors/color/preservative | 1.24 |

TABLE 9
Formula #728: Undermixed cellulose gel

| | Amount |
|---|---|
| Ingredient | (weight percent) |
| Sweetening agent, including sugar and corn syrup | 56 |
| Shortening | 25 |
| Water | 11.8 |
| Starch Wheat | 4.0 |
| Starch Potato | 0.5 |
| Cellulose gel/cellulose gum | 0.31 |
| Pectin | 0.25 |
| Fat sequestering agent | 0.10 |
| Distilled monoglycerides | 0.38 |
| Polysorbate 60 | 0.25 |
| DATEM | 0.13 |
| Sodium hydroxide | 0.09 |
| Flavors/color/preservative | 1.24 |

For each of the Formulations #722 through #728, the following process was followed to prepare the frosting. For the emulsifier slurry, hot water (160° F.) was put into a small Groen kettle with agitation. Sodium hydroxide was added to the water, followed by the emulsifier blend (prepared as described above in Example 1). The mixture was mixed for 5 minutes.

The cellulose gel/gum slurry was prepared in a Breddo mixer by mixing cellulose gel, cellulose gum, and sugar in 100° F. water for 10 minutes. Corn syrup was added and the mixture was mixed for an additional 2 minutes. The pectin slurry was prepared in a Waring blender by mixing pectin and sugar in 160° F. water for 10 minutes.

The hydrocolloid slurries, minors and flavors were mixed in the Littleford paddle mixer for 1 minute. Two-thirds of the sugar (including wheat starch) was added to the mixer and the mixture was blended for 60 seconds, then blended and smized for 90 seconds. The remaining sugar (including wheat starch) was added, then blended for 90 seconds.

The emulsifier slurry was added while blending, followed by blending for 1 minute, then blending and smizing for 1 minute. The shortening was added while blending, followed by blending for 3 minutes. The mixture was blended and smized for approximately 60 seconds, until the mixture reached a target density of 1.09 to 1.13 cc/g.

Undermixed Cellulose Gel

For formulation #728, the cellulose gel/gum blend was mixed for 2 minutes (versus the 10-minute mixing described for the remaining samples above). Corn syrup was then added and mixed for 2 minutes. The remaining procedure was the same as described in this Example for Formulation #722-727.

For each sample, the mixer was run at 25 Hz and the homogenizer was run at a pressure of 750 psi. The formulations were cooled through the votator until they reached the temperature of 89° F. ±3° F.

Formulations were stored at ambient temperatures until testing. For temperature cycling, each formulation was heated from ambient temperature (75° F.) to 100° F., then allowed to cool back to ambient temperature (75° F.). Viscosity versus temperature measurements were made with a Haake RS 100 Controlled Stress Rheometer. Programming of the rheometer, data acquisition and analysis were done using Haake Rheowin software. Temperature was controlled using a Haake TC81 Peltier system. The method for temperature cycling consisted of two temperature step sequences. The Haake TC81 Peltier system heated the sample in five-degree increments from 75° to 100° F., measuring viscosity at each temperature step. The temperature steps were then reversed and the sample was cooled from 100° to 75° F. The shear rate was 1 liter/second during temperature cycling, with a three-minute hold time between steps.

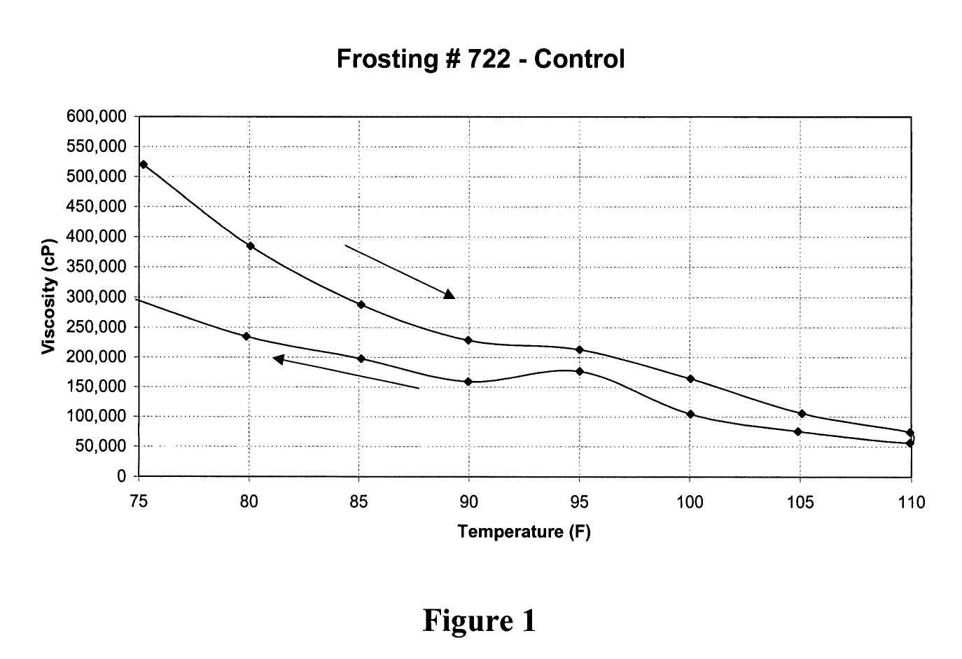

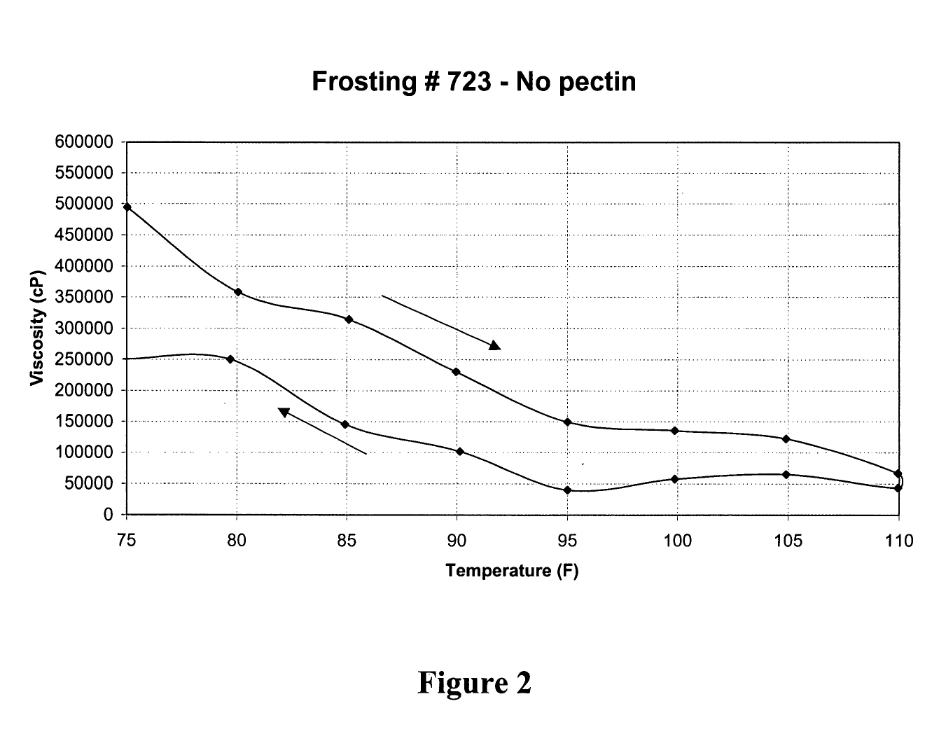

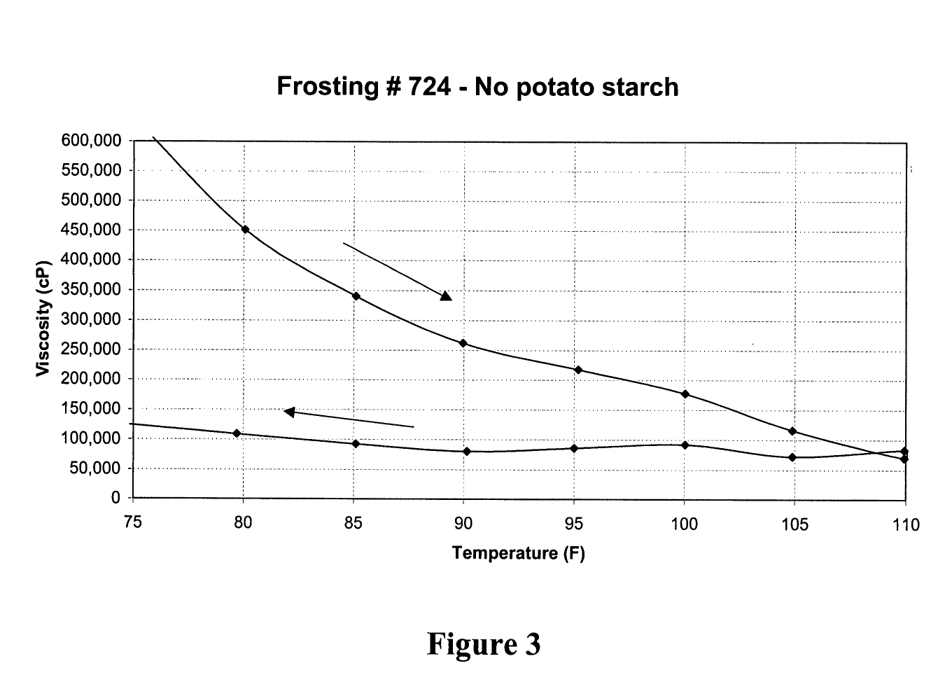

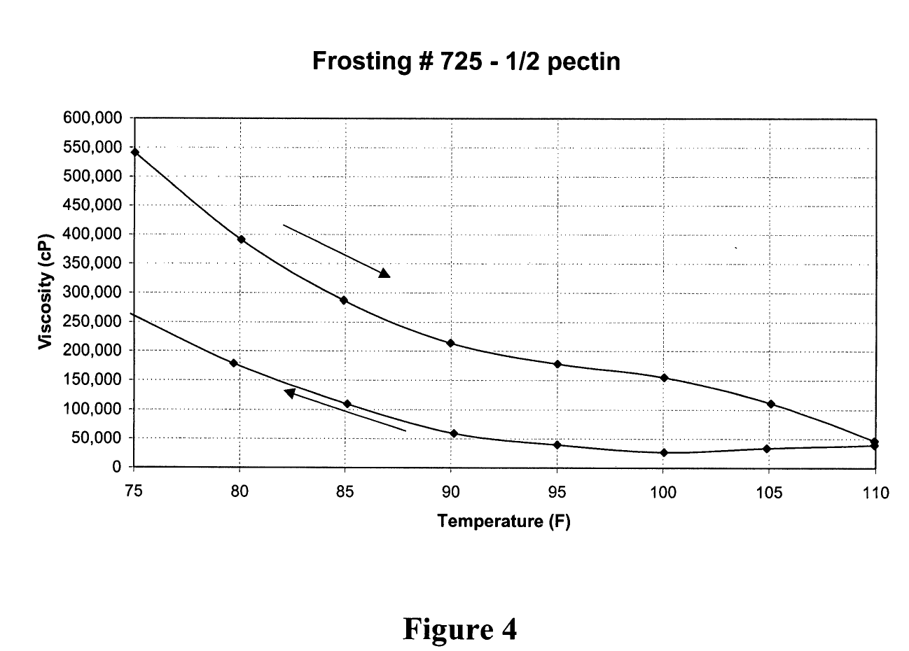

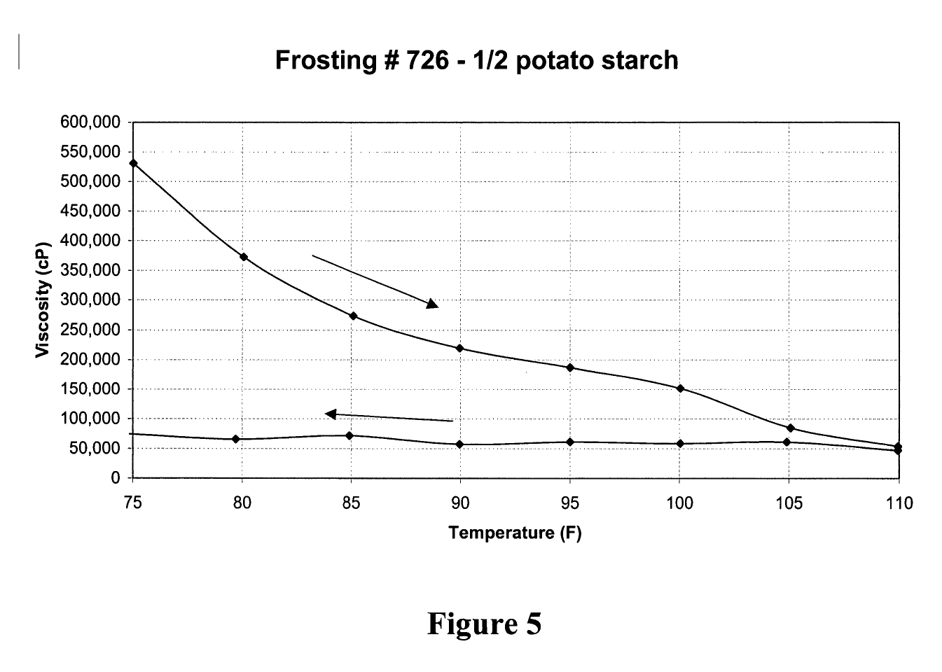

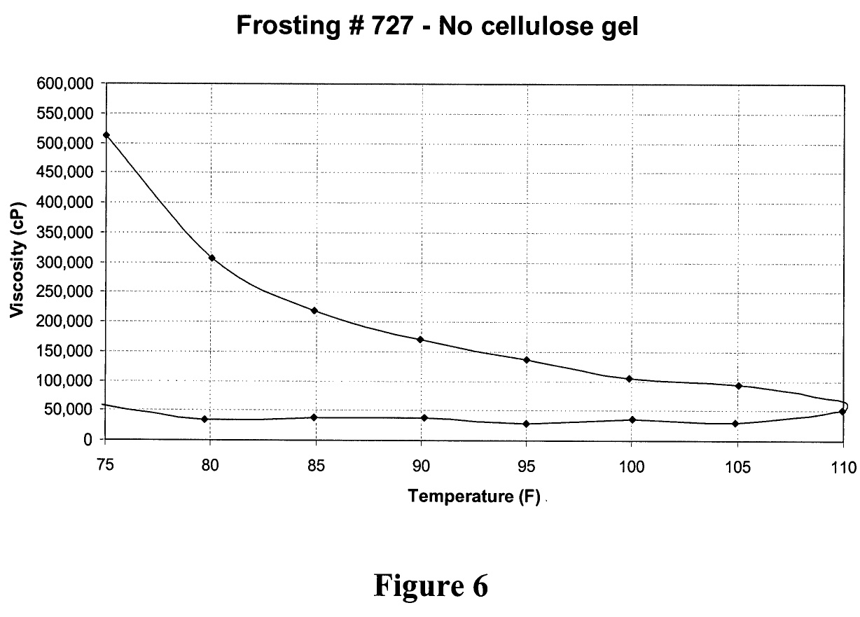

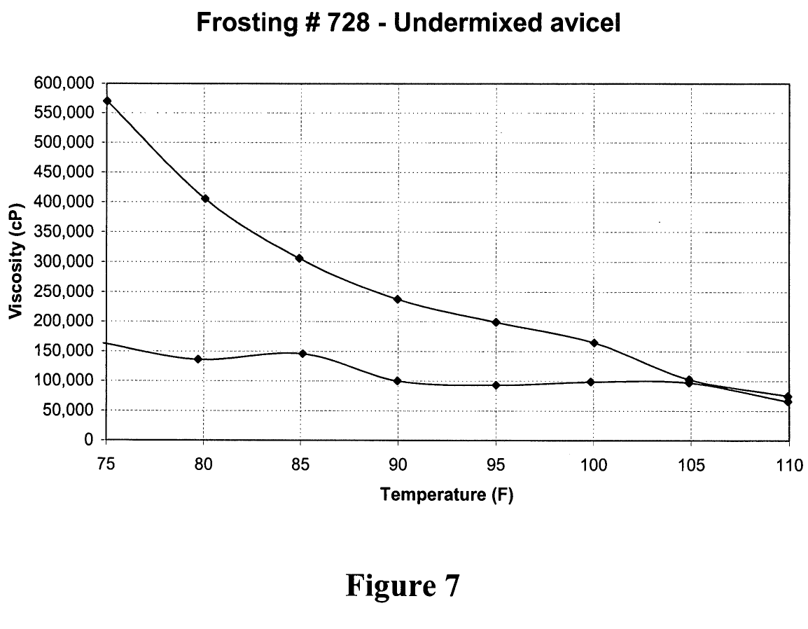

Tables 3A to 9A show temperature and viscosity data for each formulation. Corresponding cooling curves for each of the samples (data plotted in graphic form, with viscosity represented in cP on the Y axis, and temperature represented in ° F. on the X axis) are illustrated in FIGS. 1-7.

TABLE 3A
Frosting #722 - control

| T [° C.] | T [° F.] | f [cP] |
|---|---|---|
| 24 | 75 | 519,900 |
| 27 | 80 | 384,400 |
| 30 | 85 | 287,800 |
| 32 | 90 | 228,500 |
| 35 | 95 | 212,800 |
| 38 | 100 | 163,700 |
| 41 | 105 | 105,600 |
| 43 | 110 | 74,360 |
| 43 | 110 | 56,560 |
| 41 | 105 | 75,810 |
| 38 | 100 | 104,400 |
| 35 | 95 | 176,200 |
| 32 | 90 | 158,700 |
| 30 | 85 | 197,500 |
| 27 | 80 | 234,800 |
| 24 | 75 | 296,200 |

TABLE 5A
Frosting #724 - No Potato starch

| T [° C.] | T [° F.] | f [cP] |
|---|---|---|
| 24 | 75 | 638,200 |
| 27 | 80 | 451,200 |
| 30 | 85 | 340,400 |
| 32 | 90 | 261,900 |
| 35 | 95 | 217,500 |
| 38 | 100 | 177,400 |
| 41 | 105 | 116,200 |
| 43 | 110 | 69,950 |
| 43 | 110 | 83,060 |
| 41 | 105 | 72,110 |
| 38 | 100 | 91,820 |
| 35 | 95 | 86,000 |
| 32 | 90 | 80,300 |
| 30 | 85 | 92,680 |
| 27 | 80 | 108,900 |
| 24 | 75 | 124,600 |

TABLE 4A
Frosting #723 - No pectin

| T [° C.] | T [° F.] | f [cP] |
|---|---|---|
| 24 | 75 | 494200 |
| 27 | 80 | 357900 |
| 30 | 85 | 314500 |
| 32 | 90 | 230200 |
| 35 | 95 | 149400 |
| 38 | 100 | 135800 |
| 41 | 105 | 122200 |
| 43 | 110 | 66500 |
| 43 | 110 | 43570 |
| 41 | 105 | 64960 |
| 38 | 100 | 57330 |
| 35 | 95 | 39920 |
| 32 | 90 | 101800 |
| 29 | 85 | 145400 |
| 27 | 80 | 250300 |
| 24 | 75 | 250600 |

TABLE 6A
Frosting #725 - ½ pectin

| T [° C.] | T [° F.] | f [cP] |
|---|---|---|
| 24 | 75 | 541,000 |
| 27 | 80 | 390,600 |
| 29 | 85 | 287,100 |
| 32 | 90 | 213,900 |
| 35 | 95 | 178,200 |
| 38 | 100 | 154,900 |
| 41 | 105 | 111,300 |
| 43 | 110 | 46,600 |
| 43 | 110 | 39,650 |
| 41 | 105 | 34,070 |
| 38 | 100 | 27,240 |
| 35 | 95 | 39,650 |
| 32 | 90 | 59,110 |
| 30 | 85 | 109,700 |
| 27 | 80 | 178,400 |
| 24 | 75 | 263,600 |

TABLE 7A
Frosting #726 - ½ Potato starch

| T [° C.] | T [° F.] | f [cP] |
|---|---|---|
| 24 | 75 | 530,500 |
| 27 | 80 | 372,100 |
| 30 | 85 | 273,300 |
| 32 | 90 | 219,300 |
| 35 | 95 | 186,800 |
| 38 | 100 | 151,200 |
| 41 | 105 | 84,870 |
| 43 | 110 | 53,860 |
| 43 | 110 | 47,060 |
| 41 | 105 | 61,340 |
| 38 | 100 | 58,370 |
| 35 | 95 | 61,190 |
| 32 | 90 | 57,220 |
| 29 | 85 | 71,520 |
| 27 | 80 | 65,560 |
| 24 | 75 | 74,280 |

TABLE 8A
Frosting #727 - No cellulose gel

| T [° C.] | T [° F.] | f [cP] |
|---|---|---|
| 24 | 75 | 512,400 |
| 27 | 80 | 306,800 |
| 29 | 85 | 218,200 |
| 32 | 90 | 170,600 |
| 35 | 95 | 136,300 |
| 38 | 100 | 104,700 |
| 41 | 105 | 93,580 |
| 43 | 110 | 64,880 |
| 43 | 110 | 51,080 |
| 41 | 105 | 29,000 |
| 38 | 100 | 34,940 |
| 35 | 95 | 27,550 |
| 32 | 90 | 37,400 |
| 29 | 85 | 37,010 |
| 27 | 80 | 33,490 |
| 24 | 75 | 58,700 |

TABLE 9A
Frosting #728 - Undermixed cellulose gel

| T [° C.] | T [° F.] | f [cP] |
|---|---|---|
| 24 | 75 | 569,600 |
| 27 | 80 | 405,400 |
| 29 | 85 | 306,000 |
| 32 | 90 | 237,500 |
| 35 | 95 | 198,800 |
| 38 | 100 | 164,500 |
| 41 | 105 | 102,700 |
| 43 | 110 | 74,700 |
| 43 | 110 | 65,830 |
| 41 | 105 | 96,870 |
| 38 | 100 | 98,570 |
| 35 | 95 | 92,930 |
| 32 | 90 | 100,000 |
| 30 | 85 | 145,700 |
| 27 | 80 | 135,900 |
| 24 | 75 | 163,000 |

Results illustrate the synergistic effect of the combination of cellulose, starch, and polysaccharide gum in the inventive viscosity enhancer. Starting viscosities for all formulations were similar; however, once heated, the intermediate viscosities and final viscosities (after cooling to ambient temperature) were significantly different, depending upon the formulation of the viscosity enhancer. Moreover, visual inspection of the samples included in this Example resulted in the observation that many if not all of the vanilla samples separated after heating to 100° F. A thick, sticky clear layer was visible at the surface of the viscometer after the test was complete. The tables and graphs show that the measured viscosity increased very little as the samples that lacked components of the viscosity enhancer were cooled. These separated layers were not observed with the control sample (Sample #722), which was made in accordance with the inventive concepts.

Further, regarding Formulation #728 (undermixed cellulose gel), the results illustrate that the amount of shear and duration of mixing of the cellulose gel can impact the final viscosity of the inventive frosting compositions. The dispersion of cellulose gel and other components in the composition were analyzed by viewing composition with a light microscope using polarized light. Control samples of each ingredient were used as references.

A compound light microscope with polarized light capabilities was used. The microscope included objectives and eyepieces that allow a final magnification between 100 and 200. The polarizing filter and the analyzing filter were partially crossed so that the field was not completely dark, allowing viewing of materials that are not birefringent at the same time with birefringent ingredients. Each ingredient was viewed suspended in immersion oil or light paraffin oil and water to determine its physical appearance under various conditions of hydration. Results indicated that cellulose gel, in its unhydrated state, contained many agglomerates of both birefringent and non-birefringent materials. Some of the birefringent materials appeared to be colorful rectangular pieces. When the cellulose gel was fully dispersed, there was an even distribution of these short rectangular pieces with no apparent agglomerates (data not shown).

Similar results were achieved with chocolate frosting formulations (data not shown).

Example 4 (Comparative)

This Example illustrates the difference in viscosity profiles for the inventive compositions versus commercially available frosting compositions.

For this Example, both chocolate and vanilla frosting formulations were compared. Formulations CH S2 and Van G2 were the following:

TABLE 10
Sample CH S2: Chocolate flowable frosting

| | Amount |
|---|---|
| Ingredient | (weight percent) |
| Sweetening agent, including sugar and corn syrup | 46.2 |
| Shortening | 25 |
| Water | 16 |
| Starch wheat | 4 |
| Starch potato | 1 |
| Pectin | 0.16 |
| Cellulose gel/cellulose gum | 0.18 |
| Distilled monoglycerides | 0.38 |
| Sodium stearoyl lactylate | 0.13 |
| Polysorbate 60 | 0.25 |
| Sodium hydroxide | 0.05 |
| Flavor/color/preservative | 6.5 |
| Fat sequestering agent | 0.10 |

TABLE 11
Sample Van G2: Vanilla flowable frosting

| Ingredient | Amount (weight percent) |
|---|---|
| Sweetening agent, including sugar and corn | 56.2 |
| syrup | |
| Shortening | 25.0 |
| Water | 11.5 |
| Starch wheat | 4.0 |
| Starch potato | 0.5 |
| Cellulose gel/cellulose gum | 0.31 |
| Pectin | 0.25 |
| Distilled monoglycerides | 0.38 |
| Polysorbate 60 | 0.25 |
| Emulsifier datem | 0.13 |
| Sodium hydroxide | 0.09 |
| Fat sequestering agent | 0.10 |
| Flavors/coloring/preservative | 1.24 |

For comparative samples, commercially available chocolate (Betty Crocker (“BC”), Pillsbury (“PB”) and Duncan Hines (“DH”)) and vanilla (Betty Crocker (“BC”) and Pillsbury (“PB”)) samples were obtained. Each of the samples were heated to 100° F., then allowed to cool to ambient temperature (75° F.). During the temperature cycle, viscosity measurements were taken by as described above in Example 3.

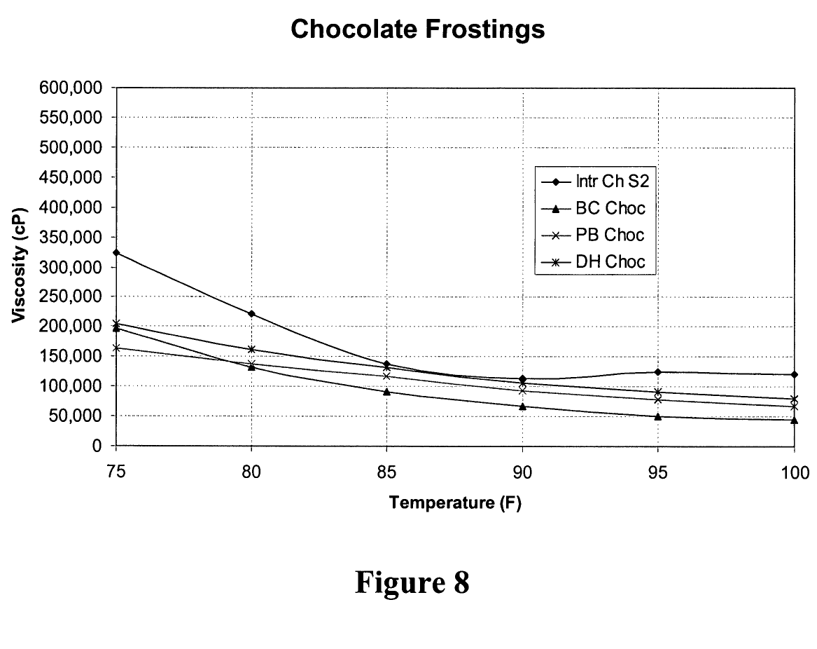

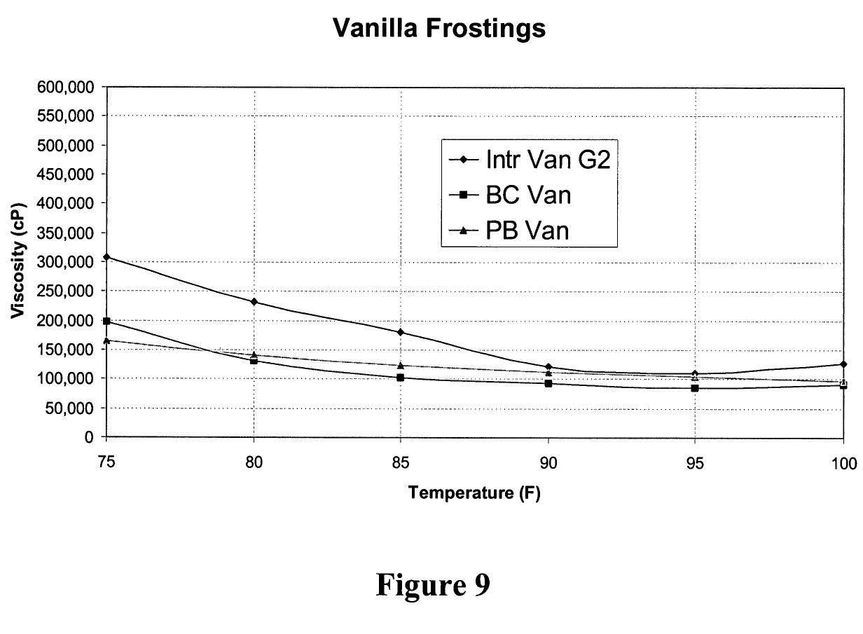

Viscosities during cooling of the products from 100° F. to 75° F. are illustrated below in Tables 12 and 13. Corresponding cooling curves for each of the samples (data plotted in graphic form, with viscosity represented in cP on the Y axis, and temperature represented in ° F. on the X axis) are illustrated in FIGS. 8 and 9.

TABLE 12
Chocolate cooling viscosities

| T [° F.] | Intr Ch S2 | BC Choc | PB Choc | DH Choc |
|---|---|---|---|---|
| 100 | 120,000 | 44,380 | 67,510 | 79,020 |
| 95 | 124,500 | 50,820 | 78,770 | 91,240 |
| 90 | 113,500 | 66,950 | 93,370 | 106,700 |
| 85 | 136,600 | 91,660 | 117,200 | 132,300 |
| 80 | 220,800 | 131,100 | 138,300 | 161,300 |
| 75 | 323,300 | 197,100 | 164,300 | 204,700 |

TABLE 13
Vanilla cooling viscosities

| T [° F.] | Intr Van G2 | BC Van | PB Van |
|---|---|---|---|
| 100 | 126,700 | 91,240 | 96,850 |
| 95 | 109,900 | 85,340 | 104,100 |
| 90 | 122,300 | 93,280 | 112,300 |
| 85 | 180,000 | 102,300 | 123,700 |
| 80 | 232,000 | 131,700 | 141,000 |
| 75 | 307,400 | 196,700 | 165,100 |

Results illustrate that frosting formulations in accordance with the invention provide final viscosities after cooling that are significantly higher than commercially available frosting formulations. Frostings made in accordance with the invention displayed a final viscosity greater than 3000,000 cP, compared to final viscosities of 200,000 cP or less for commercially available frosting compositions. After heating and then cooling, the inventive compositions change significantly in viscosity, from about 120,000 cP to 300,000 cP or more. In contrast, the comparative frosting formulations did not show as significant a change in viscosities. Not only are the heated viscosities lower than that of the inventive formulations, but the final, cooled viscosities are significantly less as well. Put another way, the difference in viscosity from heated to cooled for inventive chocolate frostings was greater than 200,000 cP, whereas the difference in viscosity for comparative chocolate frostings was less than 153,000 cP. For vanilla frostings, the difference among frostings was even greater. For inventive vanilla frostings, the difference from heated to cooled viscosities was greater than 180,000 cP, whereas the difference for comparative vanilla frostings was 105,000 cP or 68,000 cP, respectively.

These comparative examples illustrate the ability of the inventive formulations to provide a topping composition with a controlled viscosity profile, which allows the topping compositions to provide a “flowable” viscosity during application to a food product, followed by a “set” viscosity after cooling.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims. All patents, patent documents, and publications cited herein are hereby incorporated by reference as if individually incorporated.

1. A flowable topping composition having a controlled viscosity profile, the composition comprising on a weight basis:
a. 40 to 70% sweetening agent;
b. 15 to 25% shortening;
c. 0.5 to 2% emulsifier;
d. 10 to 20% moisture; and
e. viscosity enhancer comprising cellulose, starch, and polysaccharide gum.

2. The flowable topping composition according to claim 1 wherein the cellulose is selected from hydroxypropyl cellulose, microcrystalline cellulose, methylcellulose, carboxymethylcellulose, sodium carboxymethylcellulose, and mixtures of these.

3. The flowable topping composition according to claim 1 wherein the starch is selected from potato, barley, corn, rice, waxy maize, high amylose corn, wheat, sweet potato, sorghum, arrowroot, and tapioca starch, and mixtures of these.

4. The flowable topping composition according to claim 1 wherein the polysaccharide gum is selected from pectin, xanthan gum, locust bean gum, gelatin, agar, agar-agar, carrageenan, algins, gellan gum, guar gum, gum arabic, and mixtures of these.

5. The flowable topping composition according to claim 1 wherein the composition exhibits an initial viscosity in the range of 400,000 cps to 700,000 cps at ambient temperatures, an intermediate viscosity in the range of 70,000 cps to 160,000 cps when heated to a temperature in the range of 90° F. to 105° F., and a final viscosity in the range of 230,000 cps to 330,000 cps when cooled to a temperature in the range of 70° F. to 80° F.

6. The flowable topping composition according to claim 1 wherein the viscosity enhancer comprises 40 to 90% starch.

7. A flowable topping composition comprising:
a. sweetening agent;
b. shortening;
c. emulsifier; and
d. viscosity enhancer in an amount in the range of 0.5 to 3% on a weight basis, the viscosity enhancer comprising cellulose, starch, and polysaccharide gum,
wherein the flowable topping composition has a moisture content of 10 to 20%.

8. The flowable topping composition according to claim 7 wherein the cellulose is selected from hydroxypropyl cellulose, microcrystalline cellulose, methylcellulose, carboxymethylcellulose, sodium carboxymethylcellulose, and mixtures of these.

9. The flowable topping composition according to claim 7 wherein the starch is selected from potato, barley, corn, rice, waxy maize, high amylose corn, wheat, sweet potato, sorghum, arrowroot, and tapioca starch, and mixtures of these.

10. The flowable topping composition according to claim 7 wherein the polysaccharide gum is selected from pectin, xanthan gum, locust bean gum, gelatin, agar, agar-agar, carrageenan, algins, gellan gum, guar gum, gum arabic, and mixtures of these.

11. The flowable topping composition according to claim 7 wherein the composition exhibits an initial viscosity in the range of 400,000 cps to 700,000 cps at ambient temperatures, an intermediate viscosity in the range of 70,000 cps to 160,000 cps when heated to a temperature in the range of 90° F. to 105° F., and a final viscosity in the range of 230,000 cps to 330,000 cps when cooled to a temperature in the range of 70° F. to 80° F.

12. The flowable topping composition according to claim 7 wherein the viscosity enhancer comprises 40 to 90% starch.

13. A flowable topping composition comprising sweetening agent, shortening, emulsifier; and viscosity enhancer comprising cellulose, starch, and polysaccharide gum, wherein the topping composition exhibits an initial viscosity in the range of 400,000 cps to 700,000 cps at ambient temperatures, an intermediate viscosity in the range of 70,000 cps to 160,000 cps when heated to a temperature in the range of 90° F. to 105° F., and a final viscosity in the range of 230,000 cps to 330,000 cps when cooled to a temperature in the range of 70° F. to 80° F.

14. The flowable topping composition according to claim 13 wherein the cellulose is selected from hydroxypropyl cellulose, microcrystalline cellulose, methylcellulose, carboxymethylcellulose, sodium carboxymethylcellulose, and mixtures of these.

15. The flowable topping composition according to claim 13 wherein the starch is selected from potato, barley, corn, rice, waxy maize, high amylose corn, wheat, sweet potato, sorghum, arrowroot, and tapioca starch, and mixtures of these.

16. The flowable topping composition according to claim 13 wherein the polysaccharide gum is selected from pectin, xanthan gum, locust bean gum, gelatin, agar, agar-agar, carrageenan, algins, gellan gum, guar gum, gum arabic, and mixtures of these.

17. A method of making a flowable topping composition comprising steps of:
a. preparing a cellulose slurry by hydrating the cellulose;
b. preparing a polysaccharide gum slurry by hydrating the polysaccharide gum;
c. combining the cellulose slurry with the polysaccharide gum slurry;
d. mixing a starch with the combination obtained in step (c), thereby forming a viscosity enhancer;
e. combining the viscosity enhancer with sweeteners, shortening, and emulsifier to provide a flowable topping composition.

18. A method of providing a topping composition to a baked good, the method comprising steps of:
a. obtaining a topping composition comprising sweetening agent, shortening, emulsifier, and viscosity enhancer in an amount in the range of 0.5 to 3% on a weight basis, the viscosity enhancer comprising cellulose, starch, and polysaccharide gum;
b. heating the topping composition to a temperature in the range of 90° F. to 105° F.;
c. applying the topping composition onto a baked good; and
d. allowing the topping composition to set up on the baked good to a viscosity in the range of 230,000 cps to 330,000 cps.

19. The method according to claim 18 wherein the step of applying the topping composition comprises pouring the topping composition onto the baked good.

20. The method according to claim 18 wherein the step of applying the topping composition comprises applying the topping composition to a warm baked good.

21. The method according to claim 20 wherein the warm baked good comprises a baked good having an internal temperature of 120° F. or more.
